(19) United States
(12) Patent Application Publication
(10) Pub. No.: US 2016/0072344 A1
(43) Pub. Date: Mar. 10, 2016

(54) HIGH-SPEED ELECTRIC MOTOR

(71) Applicant: GE Energy Power Conversion Technology Ltd., Rugby, Warwickshire (GB)

(72) Inventors: Lionel DURANTAY, Frouard (FR); Manea LAMBOTTE, Vandieres (FR)

(21) Appl. No.: 14/377,293

(22) PCT Filed: Feb. 8, 2013
(86) PCT No.: PCT/EP2013/052608

§ 371 Date: Aug. 7, 2014

(30) Foreign Application Priority Data
Feb. 10, 2012 (FR) 1251281

(51) Int. Cl. H02K 1/22; H02K 1/02; H02K 15/12; H02K 5/12; H02K 15/00; H02K 5/02; H02K 17/16

(52) U.S. Cl. CPC H02K 1/22; H02K 5/02; H02K 1/02; H02K 17/165; H02K 5/12; H02K 15/0012; H02K 15/12

(57) ABSTRACT

This electric motor comprises a stator (12) and a rotor (14) able to turn at a rate of rotation of greater than 8000 revolutions per minute, said rotor (14) comprises a magnetic body (18) carried by a rotation shaft (19), the magnetic body (18) delimiting an external lateral surface (20). The motor comprises a protective cladding (28) on the exterior lateral surface (20) of the magnetic body (18).

### FIELD OF THE INVENTION

Embodiments of the present invention relate to a motor, and, more particularly, a motor of the electric type comprising a stator and a rotor, capable of rotating at speeds in excess of 8000 revolutions per minute, whereby the said rotor comprises a magnetic element supported by a rotating shaft and the magnetic body defines an outer lateral surface.

### BACKGROUND OF THE INVENTION

When hydrocarbon gases are being used, it is known that compressor drive motors can be placed directly in the gas for cooling purposes.

Motors which are protected by a lining are known, these can be placed in a gaseous medium but they are less efficient, because their speed of rotation is relatively slow and their performance is lower as a result of the additional losses due to the lining.

Motors with higher speeds of rotation are also known. These motors have to operate very quickly and for this reason their rotors are formed from a stack of plates and windings. Consequently, in aggressive environments they deteriorate very quickly under the effects of corrosion with the result that they are unusable in the field of gas extraction.

One of the aims of the present invention is thus to propose a high speed motor that can be used in gaseous environments and that has a satisfactory life expectancy in such environments.

### BRIEF SUMMARY OF THE INVENTION

To this end, embodiments of the present invention propose a motor of the electric type comprising a stator and a rotor, capable of rotating at speeds in excess of 8000 revolutions per minute, whereby the said rotor comprises a magnetic element supported by a rotating shaft and the magnetic body defines an outer lateral surface, characterised in that it comprises a protective coating on the outer lateral surface of the magnetic body of the rotor.

Depending on the particular embodiment, the motor according to the present invention comprises one or more of the following features: the protective coating is made of polyether ether ketone (PEEK),the protective coating contains between 5% and 25% of PEEK, the magnetic body comprises a stack of plates, the sides of which form the outer lateral surface and the protective cladding covers the sides of the plates, the motor comprises an intermediary layer of a nickel alloy between the outer lateral surface and the protective coating, the rotor is in the form of bars connected by end rings arranged axially on either side of the magnetic body and the protective cover also covers the said end rings, the protective coating is made of SKIDCOAT, the thickness of the coating is between 0.1 and 2 mm, and the surface of the coating is ground mechanically.

Embodiments of the present invention also provide a process for manufacturing a motor of the type defined above, comprising the application of the protective coating to the outer lateral surface of the magnetic body by means of a plasma spray process.

The process according to embodiments of the present invention comprises one or more of the following features: the process comprises a mechanical grinding stage of the outer surface of the protective coating, and the application of the protective coating by a plasma spraying process is preceded by the deposition of an underlayer of a nickel alloy on the outer lateral surface of the magnetic body, effected by heating the rotor.

Embodiments of the present invention also relate to the use of a motor such as that described above in an environment containing a hydrocarbon gas.

### BRIEF DESCRIPTION OF THE DRAWINGS

Embodiments of the present invention will be more clearly understood by reading the following description, which is given only by way of example, and with reference to the following drawings, in which:

FIG. 1 is a side view of a motor according to an embodiment of the present invention, and

FIG. 2 is an end view of the motor shown in FIG. 1.

### DETAILED DESCRIPTION OF THE INVENTION

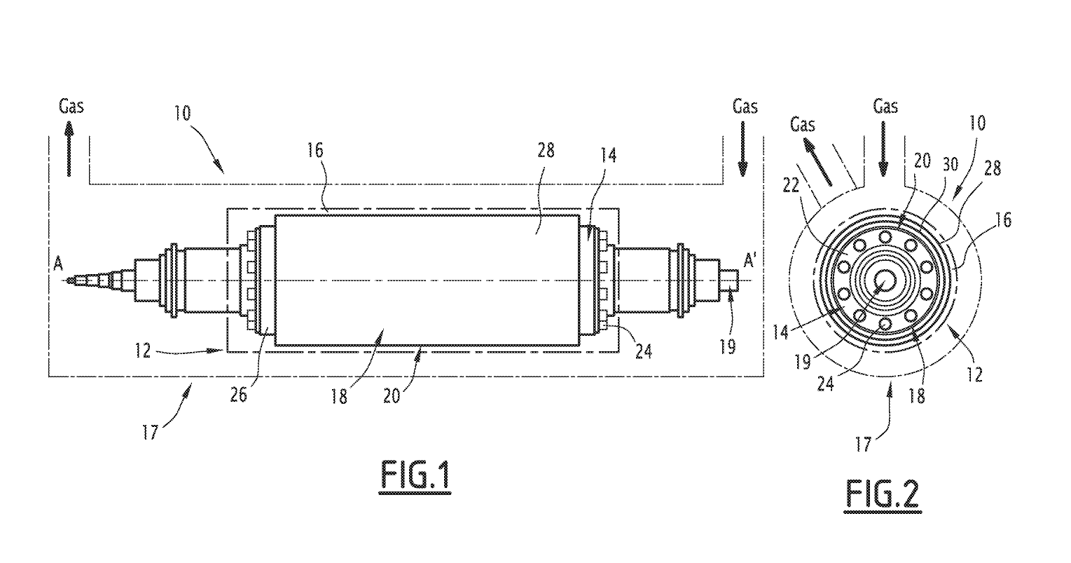

As shown in FIG. 1, motor 10 comprises a fixed stator 12 and a mobile rotor 14, arranged inside the stator 12. The stator 12 and the rotor 14 both rotate around an axis of rotation A-A′. They are separated by a gap 16.

The stator 12 is fitted with electrical coils, which are already known as such.

The motor comprises a casing 17 around which there circulates a hydrocarbon gas, notably a natural gas. As it circulates, this gas provides cooling for the motor 10.

The rotor 14 comprises a magnetic body 18 which is cylindrical in shape and which is carried by a rotary shaft 19. The magnetic body 18 defines an outer lateral surface 20. The magnetic body comprises a stack of plates 22, the sides of which combine to form the outer lateral surface. Bars 24 forming a squirrel cage pass through the stack of plates 22 in a direction that is parallel to the axis of rotation A-A′. These bars are electrically connected at their ends by end rings 26 located axially on either side of the magnetic body 18.

The outer lateral surface 20 is symmetrical around the axis of rotation A-A′ of the rotor 14. It has a protective coating 28 to counter the influences of the environment. The thickness of this coating is between 0.1 and 2 mm. The protective coating is applied directly onto the sides of the plates.

This protective coating 28 is a polymer-ceramic composite Il compo e du polyétheréthercétone (PEEK) à un pourcentage massique compris entre 5% et 25%. comprising polyether ether ketone (PEEK) at between 5% and 25% by weight. Advantageously, the protective coating 28 is in the form of SKIDCOAT, which is marketed by company Métallisation Nord Industrie in France. The coating is made of, for example, 90% Al₂O₃ and 10% PEEK.

Alternatively, protective coating 28 is formed from a different type of ceramic material associated with PEEK or solely from NiCr, Al₂O₃ or Cr₂O₃.

Alternatively, and more particularly, the outer lateral surface 20 is coated with a sub-layer 30, a nickel alloy, which itself receives a protective coating 28.

In an embodiment, the protective coating 28 also covers the end rings 26.

The protective coating 28 is applied to the outer lateral surface 20 by means of a plasma spraying system. The plasma is generated from a plasma gas and applied to the outer lateral surface 20. As it melts, it accelerates the material to be sprayed onto the outer lateral surface 20, thus forming the coating 28.

Once it has been deposited by the plasma, the outer surface of the protective coating 28 is mechanically ground. According to one particular embodiment, this grinding stage is carried out by a tool which is moved in a plane parallel to the axis of rotation A-A′ and brought into contact with the rotor 14. The tool or the rotor 14 is then rotated. This grinding stage generates a uniform coating without porosity and has a constant gap, thus reducing the risk of imbalance.

Alternatively, the application of the protective coating 28 by the plasma spraying system is preceded by the application of an underlayer comprising a nickel alloy onto the outer lateral surface 20 by means of heating the rotor 14.

As a result of its anti-wear and anti-corrosion properties, the protective coating 28 enables the working life of high speed motors to be prolonged and allows their use in more aggressive environments, notably in operations involving hydrocarbon gases.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electric motor, comprising:
a stator;
a rotor capable of rotating at speeds in excess of 8000 rpm, the rotor comprising a magnetic body, carried by a rotating shaft, wherein the magnetic body defines an outer lateral surface; and
a protective coating on the outer lateral surface of the magnetic body, wherein the thickness of the protective coating is between 0.1 mm and 2 mm.

2. The electric motor according to claim 1, wherein the protective coating is formed from polyether ether ketone (PEEK).

3. The electric motor according to claim 1, wherein the protective coating comprises between 5% and 25% polyether ether ketone (PEEK).

4. The electric motor according to claim 1, wherein the magnetic body comprises a stack of plates wherein sides of the stack of plates combine to form the outer lateral surface, and the protective coating covers the sides.

5. The electric motor according to claim 1, further comprising an intermediate nickel alloy between the outer lateral surface of the magnetic body and the protective coating.

6. The electric motor according to claim 1, wherein the rotor further comprises bars connected by end rings arranged axially on both sides of the magnetic body, and the protective coating covers the end rings.

7. The electric motor according to claim 1, wherein the protective coating consists of SKIDCOAT.

8. The electric motor according to claim 1, wherein a surface of the protective coating is mechanically ground.

9. A process of manufacturing an electric motor, the electric motor including a stator, a rotor capable of rotating at speeds in excess of 8000 rpm, the rotor including a magnetic body, carried by a rotating shaft, wherein the magnetic body defines an outer lateral surface, and a protective coating on the outer lateral surface of the magnetic body, wherein the thickness of the protective coating is between 0.1 mm and 2 mm, the process comprising:
applying the protective coating onto the outer lateral surface of the magnetic body with a plasma spray system.

10. The process according to claim 9, further comprising:
mechanically grinding the outer lateral surface of the protective coating.

11. The process according to claim 9, further comprising:
depositing an underlayer of nickel alloy on the outer lateral surface of the magnetic body effected by heating the rotor before applying the protective coating onto the outer lateral surface of the magnetic body with the plasma system.

12. The electric motor according to claim 1, wherein the electric motor is used in a medium comprising a hydrocarbon gas.

13. The electric motor according to claim 2, wherein the magnetic body comprises a stack of plates, wherein sides of the stack of plates combine to form the outer lateral surface, and the protective coating covers the sides.

14. The electric motor according to claim 13, further comprising an intermediate nickel alloy between the outer lateral surface of the magnetic body and the protective coating.

15. The electric motor according to claim 14, wherein the rotor further comprises bars connected by end rings arranged axially on both sides of the magnetic body, and the protective coating covers the end rings.

16. The electric motor according to claim 3, wherein the magnetic body comprises a stack of plates, wherein sides of the stack of plates combine to form the outer lateral surface, and the protective coating covers the sides.

17. The electric motor according to claim 16, further comprising an intermediate nickel alloy between the outer lateral surface of the magnetic body and the protective coating.

18. The electric motor according to claim 17, wherein the rotor further comprises bars connected by end rings arranged axially on both sides of the magnetic body, and the protective coating covers the end rings.

19. The electric motor according to claim 2, further comprising an intermediate nickel alloy between the outer lateral surface of the magnetic body and the protective coating.

20. The electric motor according to claim 2, wherein the rotor further comprises bars connected by end rings arranged axially on both sides of the magnetic body, and the protective coating covers the end rings.
